(19) United States
(12) Patent Application Publication
(10) Pub. No.: US 2024/0165437 A1
(43) Pub. Date: May 23, 2024

(54) FILTER DEVICE FOR CLEANING AIR, EMBODIED AS A FACE MASK

(71) Applicant: Universität Kassel, Kassel (DE)

(72) Inventors: Martin E. Garcia, Vellmar (DE); Claudia R. Arbeitman, Kassel (DE); Pedro Pablo Rojas, Kassel (DE); Pedro Ojeda May, Umea (SE)

(21) Appl. No.: 18/282,735

(22) PCT Filed: Mar. 16, 2022
(86) PCT No.: PCT/EP2022/056845

§ 371 Date: Sep. 18, 2023

(30) Foreign Application Priority Data
Mar. 19, 2021 (DE) 102021106813.4

(51) Int. Cl. A62B 23/02; H01B 7/30; H01B 9/00

(52) U.S. Cl. CPC A62B 23/025; H01B 7/303; H01B 9/006

(57) ABSTRACT

A filter device for rendering viruses harmless has at least one planar air permeable carrier member configured as a face mask. Electrical conductors are applied to the planar carrier member between which an electrical potential is applied, with the electrical conductors being spaced apart by 1 μm to 100 μm.

### CROSS-REFERENCE TO RELATED APPLICATIONS

This application is the U.S. National Stage of PCT/EP2022/056845 filed on Mar. 16, 2022, which claims priority to German Patent Application 102021106813.4 filed on Mar. 19, 2021, the entire content of both are incorporated herein by reference in their entirety.

### FIELD OF THE INVENTION

The invention relates to a filter device for rendering viruses harmless comprising at least one planar air permeable carrier member that is designed as a face mask.

### BACKGROUND OF THE INVENTION

Filter devices, in particular face masks, are known as so-called HEPA masks that are suitable to filter very small particulate matter from respiratory air, for example. However, face masks based on a HEPA system do not provide any retention of viruses; FFP2 masks and HEPA-H14 air filters achieve a retention of particle conglomerates from 0.3 μm to −0.5 μm in size, for example. Viruses are approximately 0.1 μm in size, whereby very close-meshed filter materials have to be used, whereby, however, the air resistance on a flow of air through the filter is increased.

As a rule, face masks are known having a structure of a plurality of filter layers that are, however, based on the principle of mechanically retaining particulate matter, which does not, however, work sufficiently to prevent an infection with viruses when there are viruses in the filter air. Aerosols are in particular present in respiratory air that are carriers of viruses and the latter can pass through filter layers that act purely mechanically as in a face mask so that retention filters that act conventionally, that is in particular purely mechanically acting retention filters, do not protect against viruses passing through the filter.

A filter device in the form of a face mask is known from CN 111869962 A that should in particular serve the elimination of viruses in that respiratory air is cleaned accordingly. The filter effect is based on different layers of textiles or planar materials, with an opposite electrical charge being present between two layers. This electric potential that is formed is here generated by the layers themselves in that a tribological effect based on friction between the layers is exploited. An electric charge is thus produced between the layers that has the result that micro droplets and to this extent also viruses should be destroyed by an electric shock.

The assured maintenance of the voltage between the two layers, that have to have only a very small distance between one another, for example 2 μm or a few μm, is disadvantageous, however. If the distance between the layers is increased, a greater voltage has to be applied as a rule since it is known that only electric fields having a strength of 10⁵ V/m to 10⁷ or more V/m actually enable an elimination of viruses, with smaller electric field strengths already being able to cause damage to viruses. The disadvantage also has to be considered here that face masks are moistened by the respiratory air, whereby the field strength has to be further increased. The moisture can, however, result in a short circuit so that the face mask becomes ineffective. If the electric field is too small, viruses cannot be destroyed.

The post-published DE 10 2020 108 786 A1 discloses a filter device for rendering viruses harmless comprising at least one planar air permeable carrier member that is designed as a face mask. The invention is disadvantageously based on the idea of providing electrical conductors between which a plasma should be generated. Ozone can thereby be produced; ions are furthermore formed, which represents a further disadvantageous, in particular when the ozone and ion formation is produced directly in front of the face or in the air that is breathed in by a person.

### SUMMARY OF THE INVENTION

The object of the invention comprises the improved performance of a filter device for cleaning air, in particular for rendering viruses harmless, and the filter device should be designed as an air mask. The principle should be based on the fact that an electrical field is used to interact with the viruses.

This object is achieved starting from a filter device for cleaning air as disclosed herein having the characterizing features. Advantageous further developments of the invention are also disclosed herein.

To achieve the object, the invention provides that electrical conductors are applied to the planar carrier member between which an electrical potential can be applied, with the electrical conductors having a spacing of 1 μm to 100 μm.

The core idea of the invention comprises the application of topographically defined electrical conductors to a side surface of the planar carrier member that can adopt a fixed spacing from one another based on their manufacturing process so that the electrical field can be defined with a predefined voltage in the same manner. The electrical field, formed on the application of an electrical voltage between the two electrical conductors, depends on the spatial spacing of the electrical conductors of different polarities and, with a minimum shape stability of the planar carrier member, the spacing between the electrical conductors of different polarities can be defined by means of the application of the conductors such that the resulting electrical field between the electrical conductors can be set in a defined manner, for example 10⁴ to 10⁶ V/m. There is advantageously the possibility here of attaching the electrical conductors substantially over the whole surface or over the whole surface of the electrical carrier and, if the planar carrier member forms a substantial component of the face mask or even forms it itself, respiratory air can be breathed in through the electrical conductors and aerosols, in particular viruses, have to pass through the spatial gap between the electrical conductors. The viruses can be exposed to the electrical field and can be rendered harmless due to the applicable electrical potential in this process.

Molecular dynamic simulations allow the assumption that so-called spike proteins of the SARS-COV-2 virus may be damaged by the effect of an electrical field, which may have the result that the virus can no longer penetrate into an organic cell so that the replication process of the virus cannot be set into motion from the start. The ostensible effect of an electrical potential between the electrical conductors is consequently an interaction with the spike proteins of the viruses that are attacked structurally such that the virus can be rendered harmless. The interaction between the electrical field and the spike proteins of the virus can have an effect on the virus here such that the mere presence of the electrical potential is sufficient to permanently damage the virus and the latter can no longer bind to the ACE2-receptor or to other receptors of a cell to be attacked in the case of other similarly acting viruses such as influenza or SARS-COV-1.

It may be sufficient in this process that the virus already undergoes irreversible conformity changes on an action of an electrical field over microseconds that structurally damage the spike protein of the virus such that the effect described above is produced. The viruses here can remain in the air without being mechanically filtered from the air; however, the viruses are to be considered inactive so that they can be inhaled without risk. An immune response can even occur here without any infection of the host. A special advantage is also due to the fact that no plasma has to be produced for the action on the viruses. Ozone and ion formation is thus also avoided directly in front of the face or in the respiratory air. The voltage per distance between the electrical conductors is smaller here than a voltage that would be required for plasma formation.

In accordance with an advantageous embodiment, the electrical conductors can be formed as electrical wires. They can be mechanically applied, in particular bound, to the planar carrier member or the electrical wires are applied to a surface of the carrier member in a deposition process or in a different manner. The electrical conductors particularly advantageously have a spacing of 5 μm to 20 μm and/or of 8 μm to 12 μm. The electrical conductors can in particular have cross-section dimensions of 1 μm to 100 μm and/or of 5 μm to 20 μm and/or of 10 μm. Since the planar carrier member is air permeable, the air to be cleaned can flow through the carrier member, with the air to be cleaned consequently also flowing through the intermediate spaces of the electrical conductors between which the electrical field is present.

A spacing between the electrical wires of 10 μm can be sufficient if a voltage of one volt is applied since an electrical field in an order of magnitude of 10⁶ V/m is thus already generated by the electrical charge. The thickness of the wires in the region specified can therefore already achieve the effect described above with a few μm. It is known that so-called superspreaders expel the microdroplets at approximately 150 km an hour when shouting or singing loudly. This corresponds to approximately 41.67 μm/μs. This means that a wire depth along the direction of flow and thus substantially perpendicular to the planar carrier member of only 50 μm would mean that the viruses pass through the region between the electrical wires under the influence of the field for longer than one μs.

Higher voltages can also be applied to simplify the manufacturing process, in particular to increase the anyway microscopic dimensions of the electrical wires. The filter device can have a voltage source for this purpose that has a voltage, for example, of 0.1 volts to 10 volts and/or of 0.5 volts to 5 volts and/or of preferably one volt. It is in particular advantageous if the voltage source is arranged at the face mask or is integrated in the face mask, for example in the form of a battery, of a rechargeable battery, of an electrical capacitor, or of a solar cell, optionally in conjunction with a rechargeable battery or a capacitor.

Within the framework of the invention, the electrical conductors on the planar carrier member can have any desired topography; the electrical conductors of different potentials advantageously do not cross, however, with it also being technically possible to provide a lattice structure, in particular a matrix structure, provided that the electrical conductors of different potentials may be insulated with respect to one another. However, provision is advantageously made here to attach the electrical conductors, between which the electrical potential can be applied, in parallel with one another on the planar carrier member and thus in particular extending linearly with respect to one another.

The filter device in the form of the face mask particularly advantageously has its own voltage source. The electrical conductors can be connected to the voltage source, in particular in that the electrical conductors are guided up to the voltage source, with the voltage source being arranged at the face mask and in particular at the carrier member. The electrical potential can thus be applied between the electrical conductors by the voltage source, with the voltage source also particularly advantageously being fastened to the planar carrier member itself. Since substantially no or at least a negligible current flows for the exploitation of the effect of the electrical potential on the viruses, the simple provision of an electrical potential from a very small voltage source attached to the carrier member is also sufficient. The voltage source can be a battery or a rechargeable battery, but in particular also comprises the possibility of designing the voltage source as a capacitor that is, for example, charged at regular intervals by an external device, for instance by means of a solar cell that can likewise be arranged at the face mask and in particular at the carrier member.

A further possibility of providing energy is an inductive charge for which the face mask has an inductive receiver unit, for example comprising a coil and/or charge electronics, and the face mask or the part of the face mask provided with the rechargeable battery or the capacitor, for example the carrier member, is placed onto an inductive transducer unit that, for example, likewise has a coil and the energy can be transmitted to the store in the face mask.

In accordance with an advantageous further development of the filter device in accordance with the invention, at least one air permeable protective member that extends in a planar manner is applied in in front of and/or behind the planar carrier member. A protective member on which the electrical conductors are arranged on the surface of the planar carrier member is advantageously applied to at least the side of the planar carrier member.

The carrier member and/or the at least one protective member are formed from a textile or also from a fiber mat, with other materials also being able to be used, in particular substrates having an air permeable property. The carrier member and the protective member can moreover also comprise biologically degradable materials, which makes a replacement and/or disposal environmentally compatible. It is also conceivable to be able to wash or dry/chemically clean the carrier member having the electrical conductors and optionally having further electrical devices, for which purpose it may be separable from the remaining mask, for example by means of hook and loop fasteners. A wear prone part of the mask can thus be disposed of and that part of the mask that is also in particular more cost intensive can be reused multiple times.

A further advantage of the filter technology in accordance with the invention is the smaller air resistance to urge the air to be cleaned through the filter device since the carrier member having the electrical conductors and optionally at least one further planar protective member can have a considerably smaller air resistance than with conventional air masks, whereby breathing is easier.

The at least one planar protective member is here applied to the whole surface of the carrier member and the carrier member and the at least one protective member are connected to one another and preferably lie on one another. A particular design is achieved with a first protective member on the first protective member and on a second protective member on the second side of the carrier member so that these three layers lie on one another and form a single filter substrate.

The structure of the electrical conductors can be linear or of lattice form, for example in that all the electrical conductors extend substantially horizontally and with additional electrical conductors being able to be provided that form a connection of the electrical conductors having the defined spacing from one another to the voltage source. It is also possible that the electrical conductors are woven, knitted, or connected in another manner with electrically nonconductive threads, in particular polymer threads, to form a planar structure and/or that the electrical conductors have a round, flat, angular, oval, or polygonal cross-section. The electrical conductors can be mechanically applied, in particular bound, to the planar carrier member or the electrical wires are applied to a surface of the carrier member in a deposition process or in another manner, for example galvanically.

The filter device is finally particularly advantageously formed in an embodiment of the face mask with a solar cell that supplies the voltage source with electrical energy. A small amount of energy is sufficient here that can maintain the charge between the electrical conductors, for example in the range of 1 volt to 10 volts on the basis of an electrical voltage while considering the charge losses.

It has been found to be particularly advantageous to manufacture the filter device formed as a face mask with a sandwich structure so that the planar carrier member has a protective member on both sides and the planar carrier member having the electrical conductors is received between the planar protective members such that they are protected from external effects.

It is also advantageous here for the air permeable planar carrier member and the planar protective members to be washable and in particular to be connected to one another such that a wet cleaning of the filter device does not damage the sandwich structure having the electrical conductors as a face mask.

The metallic wires extending in parallel with one another could be provided as a fabric or a textile for a manufacture thereof whose cost is as minimal as possible so that they extend horizontally or vertically and are e.g. woven with polymer wires that extend correspondingly perpendicular to the metallic wires, for instance as a warp and weft. A checked pattern is thus produced in which parallel metal wires are held by the electrically nonconductive polymer wires that also extend in parallel with, but perpendicular to, the metal wires. It is thus possible to cut the filters with a required length and width from a web material, for example. A comber can then e.g. raise half of the metallic wired on the one edge and raise the other half on the other edge so that small bulges are produced. The “bulges” at each edge are connected by a further metal wire, by soldering, for instance. The filter in accordance with the invention is thus produced. Such a method would be able to be implemented using existing industrial capacities.

It would also be conceivable that a carrier member is provided that is coated with a planar metallic conductor on both sides and that the metallic coating forms an electrical conductor on each side. The carrier member, formed as a film or the like, for example, is provided together with the two metallic conductor layers with a perforation through which the filter air can pass, for example by a pulsed laser, with the electrical potential between the electrical conductors in the form of the metal conductor coatings being able to be applied so that when viruses pass through the holes of the perforation they are effectively damaged by the electrical potential between the metallic conductor layers.

The object of the invention is furthermore achieved by means of a method of operating a filter device for rendering viruses harmless in accordance with the above description comprising at least one planar air permeable carrier member that is formed as a face mask or as a part of a face mask, said method comprising at least the following steps: arranging electrical conductors on the carrier member between which an electrical potential is applied; flowing through of the carrier member and thus of intermediate spaces between the electrical conductors by a flow of air; acting of the electrical potential on viruses that are moved between the electrical conductors by the flow of air. The steps of applying the electrical potential and of the flowing through of the carrier member and thus of intermediate spaces between the electrical conductors by a flow of air, and the acting of the electrical potential on viruses that are moved between the electrical conductors by the flow of air can be carried out continuously.

An interaction of the electrical voltage on an outer structure of the viruses is triggered by the action of the electrical potential between the electrical conductors on the viruses, in particular such that the spike proteins of the viruses are manipulated by the action of the electrical potential between the electrical conductors and such that a subsequent attachment of the viruses to human or animal cells is prevented.

### BRIEF DESCRIPTION OF THE DRAWINGS

Further measures improving the invention will be shown in more detail below together with the description of a preferred embodiment of the invention with reference to the Figures. There are shown:

FIG. 1 is an embodiment of a filter device in accordance with the invention in the form of a face mask;

FIG. 2 is an embodiment of the filter device in accordance with the present invention in a perspective view;

FIG. 3 is a first possible embodiment for the manufacture of the electrical conductors on a carrier member; and

FIG. 4 is a second possible embodiment for the manufacture of the electrical conductors on a carrier member.

### DETAILED DESCRIPTION OF THE INVENTION

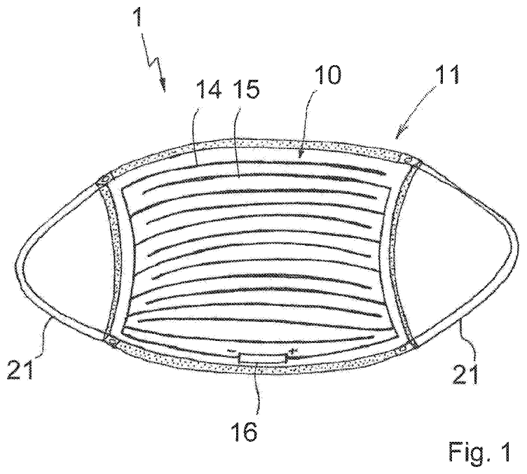

FIG. 1 shows the filter device 1 for cleaning air and the filter device 1 is formed as a face mask 11. The filter device 1 has a planar carrier member 10 as a substantial component that maps the shape of a face mask 11 so that the planar carrier member 10 can be formed in front of the mouth and nose using the shown retaining straps 21.

Electrical conductors 14 and 15, that are each connected to the connection poles of a voltage source 16, are connected at the front side on the planar carrier member 10. The electrical conductors 14 and 15 have an electrical potential with respect to one another, for example of 1 volt to 10 volts, due to the respective pole connection to the voltage source 16.

The structure of the electrical conductors 14 and 15 with respect to one another is linear, with the electrical conductors 14 being connected to one another and being attached to the negative pole of the voltage source 16. The electrical conductors 15 extend in the intermediate spaces between the electrical conductors 14 and, vice versa, the electrical conductors 14 extend in the intermediate spaces between the electrical conductors 15, that is alternately, and the respective electrical conductors 14 and 15 are connected via a respective busbar to the positive pole or negative pole of the voltage source 16. The spacing between the electrical conductors 14 and 15 can amount, for example, to 1 μm to 100 μm, preferably approximately 10 μm. The embodiment in accordance with FIG. 1 is here only shown schematically and the electrical conductors 14 and 15 substantially cover the whole area of the planar carrier member 10 and have a very planar dense structure with respect to one another overall that is shown considerably enlarged and minimized only for the purpose of graphical illustration.

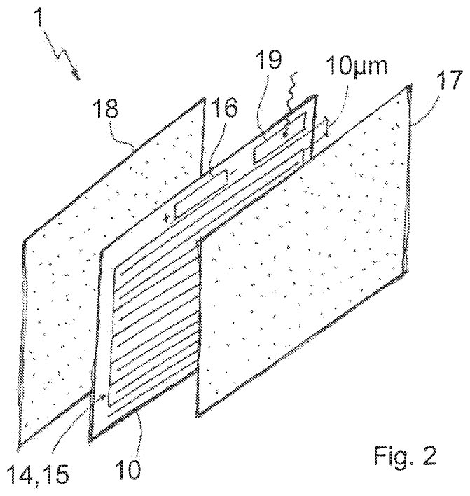

FIG. 2 shows the filter device 1 in a perspective pulled-apart design with a planar carrier member 10 arranged centrally between two planar protective members 17 and 18. The electrical conductors 14 and 15 are shown as linear on the planar carrier members 10 and the electrical conductors 14 and 15 are applied to the side of the planar carrier member 10 on which the planar protective member 17 is arranged. In the state of the filter device 1 ready for use, the planar protective members 17 and 18 are directly connected to the planar carrier member 10 so that all the planar members 10, 17, and 18 are located on one another over their whole areas.

In a manner not shown in more detail, the electrical conductors 14 and 15 are connected to the voltage source 16 and the voltage source 16 can be kept charged by a solar cell 19.

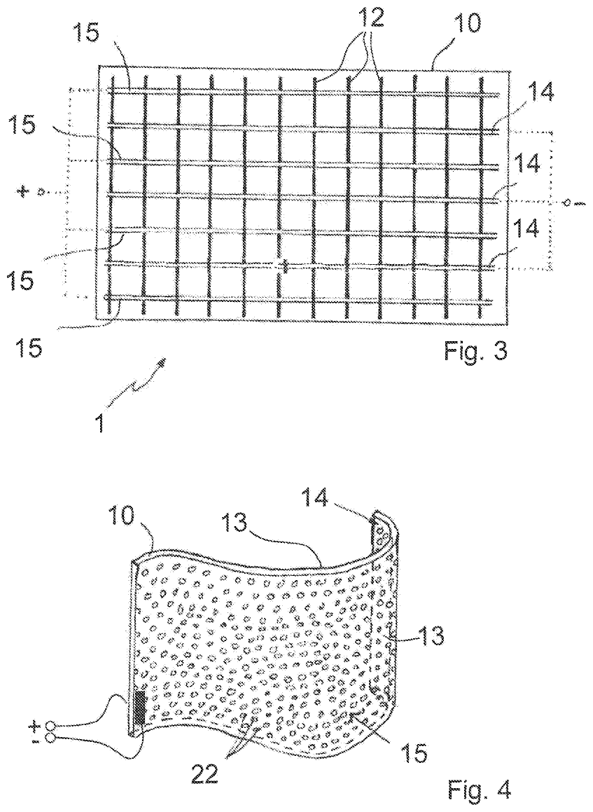

FIG. 3 shows a possible embodiment of a carrier member 10 having a fabric that is manufactured, for example, in the manner of warp and weft, with the weft threads forming the electrical conductors 14, 15, while the warp threads are not conductive, for example in that they are manufactured from a polymer thread 12, while the electrical conductors 14, 15 are formed by means of metallic wires. The warp threads and the weft threads can be provided as a fabric, with every second electrical conductor 14 being connected to the positive pole, for example, before or after the application of the fabric to the carrier member 10 and the electrical conductors 15 disposed therebetween being connected to the negative pole. The fabric here can, for example, be stamped from a fabric web in a manner adapted to the format of the carrier member 10.

FIG. 4 represents a further possible embodiment of a carrier member 10 that is coated on both sides with planar metallic conductors that form the electrical conductors 14 and 15. The carrier member 10, formed as a film or the like, for example, is provided together with the two metallic conductor layers with a perforation 22 through which the filter air can pass, for example by a pulsed laser, with the electrical potential between the electrical conductors 14 and 15 in the form of the metallic conductor coatings 13 being able to be applied so that when viruses pass through the holes of the perforation they are effectively damaged by the electrical potential between the metallic conductor layers.

The invention is not restricted in its design to the preferred embodiment specified above. A number of variants is rather conceivable that also makes use of the solution shown with generally differently designed embodiments. All the features and/or advantages, including any construction details or spatial arrangements, originating from the claims, the description, or the drawings can be essential to the invention both per se and in the most varied combinations.

### REFERENCE NUMERAL LIST

1 filter device
10 planar carrier member
11 face mask
12 polymer thread
13 surface coating
14 electrical conductor
15 electrical conductor
16 voltage source
17 planar protective member
18 planar protective member
19 solar cell
20 reception member
21 retaining strap
22 perforation

1-15. (canceled)

16. A filter device for rendering viruses harmless, comprising:
at least one planar air permeable carrier member configured as a face mask;
electrical conductors applied to the planar carrier member between which an electrical potential is applied, the electrical conductors being spaced apart by a distance of 1 μm to 100 μm.

17. The filter device in accordance with claim 16, wherein the electrical conductors are electrical wires.

18. The filter device in accordance with claim 16, wherein the electrical conductors are spaced apart by a distance of 5 μm to 20 μm and/or of 8 μm to 12 μm.

19. The filter device in accordance with claim 16, wherein the electrical conductors have cross-sectional dimensions of 1 μm to 100 μm and/or of 5 μm to 20 μm and/or of 10 μm.

20. The filter device in accordance with claim 16, wherein the electrical conductors between which the electrical potential is applied are applied to the planar carrier member in parallel with one another and/or extending in a linear manner with respect to one another.

21. The filter device in accordance with claim 16, wherein the electrical conductors each have a coating and are woven to one another.

22. The filter device in accordance with claim 16, wherein the electrical conductors are woven with polymer threads to form a conductor lattice on the carrier member.

23. The filter device in accordance with claim 16, further comprising a voltage source, the electrical conductors between which the electrical potential is applied, being connected to respective separate poles of the voltage source on the planar carrier member.

24. The filter device in accordance with claim 23, wherein:
the voltage source has a voltage of 0.1 V to 10 V and/or of 0.5 V to 5 V and/or of 1 V; and/or
the voltage source is a battery, a rechargeable battery, or an electrical capacitor; and/or
the voltage source is arranged at the face mask or is integrated in the face mask.

25. The filter device in accordance with claim 16, further comprising at least one air permeable protective member that extends in a planar manner and is applied in front of and/or behind the planar carrier member.

26. The filter device in accordance with claim 25, wherein the carrier member and/or the at least one protective member is/are formed from a textile or from a fiber mat.

27. The filter device in accordance with claim 25, wherein the electrical conductors are arranged between the planar protective member and/or the at least one planar protective member.

28. The filter device in accordance with claim 23, further comprising a solar cell that is electrically connected to the voltage source, the solar cell being arranged at the face mask or being integrated in the face mask.

29. The filter device in accordance with claim 16, further comprising a protective member arranged at both sides of the planar carrier member such that a flexible sandwich structure is formed.

30. A method of operating a filter device for rendering viruses harmless, comprising:
providing a filter device having at least one planar air permeable carrier member configured as a face mask;
arranging electrical conductors on the carrier member between which an electrical potential is applied;
flowing through the carrier member and thus through intermediate spaces between the electrical conductors a flow of air.
acting by the electrical potential on viruses that are moved between the electrical conductors by the flow of air.

31. The method in accordance with claim 30, wherein:
an interaction of electrical voltage or of the electrical potential or of an electrical field is performed on an outer structure of the viruses by the action of the electrical potential between the electrical conductors on the viruses.

32. The method in accordance with claim 31, wherein:
the viruses have spike proteins, the spike proteins being manipulated by the action of the electrical potential between the electrical conductors on the viruses such that a subsequent attachment of the viruses to human or animal cells is prevented.
